(19) United States
(12) Patent Application Publication
(10) Pub. No.: US 2010/0144579 A1
(43) Pub. Date: Jun. 10, 2010

(54) Color-Safe Detergent or Cleaning Agent having Optical Brightener

(76) Inventors: Theodor Võlkel, Erkrath (DE); Sabine Schümann, Neuss (DE); Lars Janzen, Dusseldorf (DE); Tatiana Schymitzek, Krefeld (DE)

Correspondence Address: Henkel Corporation, 10 Finderne Avenue, Bridgewater, NJ, 08807, US

(21) Appl. No.: 12/701,663

(22) Filed: Feb. 8, 2010

Related U.S. Application Data
(63) Continuation of application No. PCT/EP2008/059679, filed on Jul. 24, 2008.

(30) Foreign Application Priority Data
Aug. 8, 2007 (DE) 10 2007 037 430.7

(51) Int. Cl. C11D 3/28

(52) U.S. Cl. 510/299

(57) ABSTRACT

The invention relates to a shelf-stable aqueous detergent or cleaning agent simultaneously comprising an optical brightener and a color transfer inhibitor. The detergent or cleaning agent has a pH value in the neutral range in order to stabilize both ingredients. The invention further relates to a method for producing such a liquid detergent or cleaning agent, and to the use thereof.

### CROSS REFERENCE TO RELATED APPLICATIONS

The present application is a continuation of International Application No. PCT/EP2008/059679, filed 24 Jul. 2008, which claims priority to German Patent Application No. 10 2007 037 430.7, filed 8 Aug. 2007.

The present invention relates to an aqueous washing or cleaning agent comprising an optical brightener and a color transfer inhibitor, as well as additional conventional ingredients of washing or cleaning agents. The invention also relates to the use of washing or cleaning agents as well as processes for their manufacture.

Optical brighteners (also referred to as “whiteners”) are added to washing or cleaning agents to eliminate graying and yellowing of the treated textile fabrics. These materials are absorbed onto the fibers and effect a brightening and pseudo bleach effect by converting invisible ultraviolet radiation into visible radiation, wherein ultraviolet light absorbed from sunlight is irradiated away as weak blue fluorescence and results in pure white for the yellow shade of the grayed or yellowed washing. Washing or cleaning agents containing optical brighteners are also frequently called universal washing agents.

In order to efficiently prevent color dissolution and/or color transfer to other textiles during the washing and/or cleaning of colored textiles, a color transfer inhibitor is added to the washing or cleaning agent. The color transfer inhibitor mainly does this by forming complexes with the dyes that have detached themselves from the fabrics and are present in the wash liquor.

A pasty washing agent comprising an optical brightener and a color transfer inhibitor for use in commercial laundries is described in U.S. Pat. No. 6,329,333 B1. The washing agent is highly viscous and anhydrous.

Attempts to broaden the performance range of liquid, particularly, aqueous universal washing agents, in order to inhibit discoloration properties have failed because optical brighteners and color transfer inhibitors are incompatible in an aqueous washing agent matrix based on a conventional composition. Thus, simultaneously incorporating an optical brightener and a polymeric color transfer inhibitor into a liquid washing agent matrix results in strong cloudiness and subsequent phase separation.

This is particularly disadvantageous when, for example, it is esthetically desirable that the liquid washing or cleaning agents be clear and transparent, or at least translucent, and are also intended to be marketed in transparent/translucent packaging.

Consequently, an object of the invention is to provide a storage-stable, aqueous washing or cleaning agent comprising an optical brightener and a color transfer inhibitor.

This object is achieved by an aqueous washing or cleaning agent that comprises surfactant(s) as well as further conventional ingredients of washing or cleaning agents, wherein the agent comprises an optical brightener and a color transfer inhibitor and exhibits a pH in the range 6.5 to 7.5.

It has been surprisingly found that by adjusting the pH to the neutral range, storage stable agents can be obtained that simultaneously exhibit a brightening and a color protective effect. In addition, the obtained products are clear and esthetically appealing.

In particular, advantageous washing or cleaning agents are obtained in regard to storage stability and appearance, when the pH of the composition is in the range 6.8 to 7.2.

In order to achieve good cleaning performance, the composition preferably contains 3 wt. % or more synthetic anionic surfactant. Anionic surfactants are important ingredients of washing or cleaning agents because they remove numerous fabric stains and are particularly effective with fatty stains. It is further preferred that the synthetic anionic surfactant is chosen from alkylbenzene sulfonates, alkane sulfonates, olefin sulfonates, methyl ester sulfonates, alkyl sulfates, alkenyl sulfates, alkyl ether sulfates, alkenyl ether sulfates and mixtures thereof. These synthetic anionic surfactants are widely commercially available and possess good cleaning performance on soiled surfaces.

In a particularly preferred embodiment, the agent comprises up to 2 wt. %, preferably up to 0.5 wt. % fatty acid soaps. In a quite particularly preferred embodiment, the agent is essentially free of fatty acid soaps. It was surprisingly found that the presence of fatty acid soaps has a negative effect on the stability of washing or cleaning agents comprising an optical brightener and a color transfer inhibitor. In this respect, storage stable and clear washing or cleaning agents can be obtained when the agents are free of fatty acid soaps.

The optical brightener is preferably chosen from distyrylbiphenyls, stilbenes, disulfonic acids, coumarins, dihydroquinolinones, 1,3-diarylpyrazolines, naphthalic acid imides, benzoxazole systems, benzisoxazole systems, benzimidazole systems, heterocycle-substituted pyrene derivatives and mixtures thereof. These optical brighteners are highly stable and exhibit high stability towards light and oxygen and possess a high affinity for fibers.

The optical brighteners disodium-4,4′-bis-(2-morpholino-4-anilino-s-triazin-6-ylamino)stilbene disulfonate, disodium-2,2′-bis-(phenyl-styryl)disulfonate, 4,4′-bis[(4-anilino-6-[bis(2-hydroxyethyl)amino]-1,3,5-triazin-2-yl)amino]stilbene-2,2′-disulfonic acid, hexasodium-2,2′-[vinylene bis[(3-sulfonato-4,1-phenylene)imino[6-(diethylamino)-1,3,5-triazin-4,2-diyl]imino]]bis-(benzene-1,4-disulfonate), 2,2′-(2,5-thiophenediyl)bis[5-1,1-dimethylethyl)-benzoxazole, 2,5-bis(benzoxazol-2-yl)thiophene and mixtures thereof, can be easily and stably incorporated into a liquid washing or cleaning agent containing color transfer inhibitor.

Further preferred color transfer inhibitors are chosen from polyvinyl pyrrolidone (PVP), polyvinylimidazole (PVI), copolymers of vinyl pyrrolidone and vinylimidazole (PVP/PVI), polyvinylpyridine-N oxide, poly-N-carboxymethyl-4-vinylpyridium chloride, as well as mixtures thereof. These compounds form particularly stable complexes with the dyes dissolved out of the fabrics and can also be easily and stably incorporated into a liquid washing or cleaning agent containing optical brighteners.

The quantity of optical brighter preferably ranges from 0.001 to 0.25 wt. %, based on total weight of the washing or cleaning agent.

Furthermore, the quantity of color transfer inhibitor preferably ranges from 0.02 to 0.6 wt. %, based on total weight of the washing or cleaning agent.

The invention also relates to the use of the inventive washing or cleaning agent for washing and/or cleaning fabric articles.

In another aspect, the invention relates to a process for manufacturing an aqueous washing or cleaning agent that comprises surfactant(s), an optical brightener and a color transfer inhibitor, and further conventional ingredients of washing or cleaning agents, wherein the pH of the agent is adjusted to a value of 6.5 to 7.5.

In this regard it is additionally advantageous if the optical brightener is added at a different time than the color transfer inhibitor. In particular, it is advantageous if at least two further ingredients of the washing or cleaning agent are added between the addition of the optical brightener and the addition of the color transfer inhibitor.

Consequently, the invention also relates to a process for manufacturing an aqueous washing or cleaning agent that comprises surfactant(s), an optical brightener and a color transfer inhibitor, and further conventional ingredients of washing or cleaning agents, wherein the optical brightener is added at a different time than the color transfer inhibitor, and at least two further ingredients of the washing or cleaning agent are added between the addition of the optical brightener and the addition of the color transfer inhibitor.

The invention is described below in more detail by means inter alfa of examples.

Washing or cleaning agents according to the present invention are aqueous. In this application, “aqueous” means that water is the main solvent and is present in an amount of more than 25 wt. %.

Washing or cleaning agents according to the invention possess an optical brightener. The optical brightener is preferably chosen from distyrylbiphenyls, stilbenes, 4,4′-diamino-2,2-stilbene disulfonic acids, coumarins, dihydroquinolinones, 1,3-diarylpyrazolines, naphthalic acid imides, benzoxazole systems, benzisoxazole systems, benzimidazole systems, heterocycle-substituted pyrene derivatives and mixtures thereof.

Particularly preferred optical brighteners include disodium-4,4′-bis-(2-morpholino-4-anilino-s-triazin-6-ylamino)stilbene disulfonate (for example, Tinopal® DMS from Ciba Specialties AG), disodium-2,2′-bis-(phenyl-styryl) disulfonate (for example, Tinopal® CBS from Ciba Specialties AG), 4,4′-bis[(4-anilino-6-[bis(2-hydroxyethyl)amino]-1,3,5-triazin-2-yl)amino]stilbene-2,2′-disulfonic acid (for example, Tinopal® UNPA from Ciba Specialties AG), hexasodium-2,2′-[vinylene bis[(3-sulfonato-4,1-phenylene)imino[6-(diethylamino)-1,3,5-triazin-4,2-diyl]imino]]bis-(benzene-1,4-disulfonate) (for example, Tinopal® SFP from Ciba Specialties AG), 2,2′-(2,5-thiophendiyl)bis[5-1,1-dimethylethyl)benzoxazole (for example, Tinopal® SFP from Ciba Specialties AG) and/or 2,5-bis(benzoxazole-2-yl)thiophene.

In a particularly preferred embodiment of the invention, the washing or cleaning agent comprises disodium-4,4′-bis-(2-morpholino-4-anilino-s-triazin-6-ylamino)stilbene disulfonate and/or disodium-2,2′-bis-(phenyl-styryl)disulfonate as the optical brightener.

The amount of optical brightener can range from 0.001 to 0.25 wt. %, and preferably from 0.01 to 0.12 wt. %, each based on total weight of the washing or cleaning agent.

The washing or cleaning agent comprises a color transfer inhibitor as a further component. The color transfer inhibitor is preferably a polymer or copolymer of cyclic amines such as vinyl pyrrolidone and/or vinylimidazole. As color transfer inhibitors, suitable polymers include polyvinyl pyrrolidone (PVP), polyvinylimidazole (PVI), copolymers of vinyl pyrrolidone and vinylimidazole (PVP/PVI), polyvinylpyridine-N-oxide, poly-N-carboxymethyl-4-vinylpyridium chloride as well as mixtures of them. Polyvinyl pyrrolidone (PVP), polyvinylimidazole (PVI) or copolymers of vinyl pyrrolidone and vinylimidazole (PVP/PVI) are particularly preferably employed as color transfer inhibitors. The added polyvinyl pyrrolidones (PVP) preferably have an average molecular weight of 2,500 to 400,000, and are commercially available from ISP Chemicals as PVP K 15, PVP K 30, PVP K 60 or PVP K 90, or from BASF as Sokalan® HP 50 or Sokalan® HP 53. The added copolymers of vinyl pyrrolidone and vinylimidazole (PVP/PVI) preferably have a molecular weight in the range of 5,000 to 100,000. An example of a commercially available PVP/PVI copolymer is Sokalan® HP 56 from BASF.

The amount of color transfer inhibitor, based on total weight of the washing or cleaning agent, is preferably from 0.02 to 0.06 wt. %, and advantageously from 0.01 to 0.3 wt. %.

An important aspect of the invention concerns the pH of the liquid washing or cleaning agent. The pH should lie in the neutral range, meaning between 6.5 and 7.5, and preferably between 6.8 and 7.2. If the pH lies outside this neutral range, particularly for pH values above 7.5, there occurs a strong turbidity that is followed by phase separation.

In addition to the optical brightener and the color transfer inhibitor capsules, the washing or cleaning agent can include surfactant(s), wherein anionic, non-ionic, zwitterionic and/or amphoteric surfactants can be employed. Mixtures of anionic and non-ionic surfactants are preferred from an industrial application viewpoint. Total surfactant content of the liquid washing or cleaning agent is preferably below 60 wt. %, and particularly preferably below 45 wt. %, based on total weight of the liquid washing agent.

Preferred non-ionic surfactants include alkoxylated, advantageously ethoxylated, particularly, primary alcohols preferably containing 8 to 18 carbon atoms and, on average, 1 to 12 moles of ethylene oxide (EO) per mole of alcohol, wherein the alcohol group may be linear or, preferably, methyl-branched in the 2-position, or may contain, for example, linear and methyl-branched groups in the form of mixtures typically present in oxo alcohol groups. In particular, alcohol ethoxylates with linear alcohol groups of natural origin with 12 to 18 carbon atoms (e.g., from coco-, palm-, tallow- or oleyl alcohol) and an average of 2 to 8 EO per mole alcohol are preferred. Exemplary preferred ethoxylated alcohols include C₁₂₋₁₄ alcohols with 3 EO, 4EO or 7EO, C₉₋₁₁ alcohol with 7 EO, C₁₃₋₁₅ alcohols with 3 EO, 5 EO, 7 EO or 8 EO, C₁₂₋₁₈ alcohols with 3EO, 5EO or 7EO and mixtures thereof, as well as mixtures of C₁₂₋₁₄ alcohol with 3 EU and C₁₂₋₁₈ alcohol with 7 EO. The cited degrees of ethoxylation constitute statistically average values that can be a whole or a fractional number for a specific product. Preferred alcohol ethoxylates have a narrowed homolog distribution (narrow range ethoxylates, or NRE). In addition to these non-ionic surfactants, fatty alcohols with more than 12 EO can also be used. Examples include tallow fatty alcohol with 14 EU, 25 EO, 30 EO or 40 EU. Also, non-ionic surfactants comprising EO- and PO groups together in the molecule are employable according to the invention. Here, block copolymers with EO-PO blocks or PO-EO blocks can be added, but also EO-PO-EO copolymers or PO-EO-PO copolymers. Of course, mixed alkoxylated non-ionic surfactants can also be used, wherein EU- and PO-units are not in blocks but rather distributed statistically. Such products can be obtained by the simultaneous action of ethylene oxide and propylene oxide on fatty alcohols.

Furthermore, as additional non-ionic surfactants, alkyl glycosides that satisfy the general Formula RO(G)ₓ can be added, wherein R is a primary linear or methyl-branched, particularly 2-methyl-branched, aliphatic group containing 8 to 22, and preferably 12 to 18 carbon atoms; and G is a glycoside unit containing 5 or 6 carbon atoms, preferably glucose. The degree of oligomerization x, which defines the distribution of monoglycosides and oligoglycosides, is any number between 1 and 10, preferably 1.2 to 1.4.

Another class of preferred non-ionic surfactants which may be used, either as the sole non-ionic surfactant or in combination with other non-ionic surfactants, are alkoxylated, preferably ethoxylated or ethoxylated and propoxylated fatty acid alkyl esters, preferably containing 1 to 4 carbon atoms in the alkyl chain, in particular fatty acid methyl esters.

Non-ionic surfactants of the amine oxide type, for example, N-cocoalkyl-N,N-dimethylamine oxide and N-tallow alkyl-N,N-dihydroxyethylamine oxide, and the fatty acid alkanolamides may also be suitable. The quantity in which these non-ionic surfactants are used is preferably no more than the quantity in which the ethoxylated fatty alcohols are used and, in particular, no more than half that quantity.

Other suitable surfactants include polyhydroxy fatty acid amides corresponding to Formula (I)—

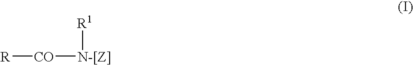

wherein RCO is an aliphatic acyl group with 6 to 22 carbon atoms; R¹ is hydrogen, an alkyl or hydroxyalkyl group with 1 to 4 carbon atoms; and [Z] is a linear or branched polyhydroxyalkyl group with 3 to 10 carbon atoms and 3 to 10 hydroxyl groups. Polyhydroxyfatty acid amides are known substances, which may normally be obtained by reductive amination of a reducing sugar with ammonia, an alkylamine or an alkanolamine and subsequent acylation with a fatty acid, a fatty acid alkyl ester or a fatty acid chloride.

Polyhydroxy fatty acid amides also includes compounds corresponding to Formula (II)—

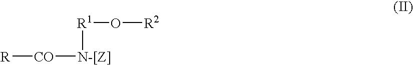

wherein R is a linear or branched alkyl or alkenyl group containing 7 to 12 carbon atoms; R′ is a linear, branched or cyclic alkyl group or an aryl group containing 2 to 8 carbon atoms; and R² is a linear, branched or cyclic alkyl group or an aryl group or an oxyalkyl group containing 1 to 8 carbon atoms, C₁₋₄-alkyl or phenyl groups being preferred; and [Z] is a linear polyhydroxyalkyl group with the alkyl chain substituted by at least two hydroxyl groups, or alkoxylated, preferably ethoxylated or propoxylated derivatives of that group.

[Z] is preferably obtained by reductive amination of a sugar such as glucose, fructose, maltose, lactose, galactose, mannose or xylose. N-alkoxy- or N-aryloxy-substituted compounds may then be converted into the required polyhydroxyfatty acid amides by reaction with fatty acid methyl esters in the presence of an alkoxide as catalyst.

The amount of non-ionic surfactants in the washing or cleaning agent is preferably from 5 to 30 wt. %, advantageously from 7 to 20 wt. % and particularly from 9 to 15 wt. %, in each case based on total weight of the washing or cleaning agent.

In addition to non-ionic surfactants, the washing or cleaning agent can also comprise anionic surfactants. The presence of anionic surfactants is a preferred embodiment of the invention. In particular, the washing or cleaning agent can comprise synthetic anionic surfactants. Exemplary synthetic anionic surfactants include alkylbenzene sulfonates, alkane sulfonates, olefin sulfonates, methyl ester sulfonates, alkyl sulfates, alkenyl sulfates, alkyl ether sulfates, alkenyl ether sulfates and mixtures thereof. Suitable surfactants of the sulfonate type include, advantageously, olefin sulfonates (i.e., mixtures of alkene- and hydroxyalkane sulfonates) and disulfonates, obtained, for example, from C₁₂₋₁₈ monoolefins having a terminal or internal double bond, by sulfonation with gaseous sulfur trioxide and subsequent alkaline or acidic hydrolysis of the sulfonation products. Alkane sulfonates, obtained for example from C₁₂₋₁₈ alkanes by sulfochlorination or sulfoxidation with subsequent hydrolysis or neutralization, are also suitable. The esters of α-sulfofatty acids (ester sulfonates) (e.g., the α-sulfonated methyl esters of hydrogenated coco-, palm nut- or tallow acids) are likewise suitable.

Further suitable anionic surfactants include sulfated fatty acid esters of glycerin. They include mono-, di- and triesters, as well as mixtures of them, such as those obtained by esterification of a monoglycerin with 1 to 3 moles fatty acid or by transesterification of triglycerides with 0.3 to 2 moles glycerin. Preferred sulfated fatty acid esters of glycerin include the sulfated products of saturated fatty acids containing 6 to 22 carbon atoms (e.g., caproic acid, caprylic acid, capric acid, myristic acid, lauric acid, palmitic acid, stearic acid or behenic acid).

Preferred alk(en)yl sulfates include the alkali metal, and especially sodium salts of the sulfuric acid half-esters derived from C₁₂-C₁₈ fatty alcohols (e.g., from coconut butter alcohol, tallow alcohol, lauryl, myristyl, cetyl or stearyl alcohol) or from C₁₀-C₂₀ oxo alcohols and those half-esters of secondary alcohols of these chain lengths. Additionally preferred are alk(en)yl sulfates of the said chain lengths containing a synthetic, straight-chained alkyl group produced on a petrochemical basis and which show a degradation behavior similar to suitable compounds based on fat chemical raw materials. C₁₂-C₁₆ alkyl sulfates and C₁₂-C₁₅ alkyl sulfates and C₁₄-C₁₅ alkyl sulfates are preferred based on washing performance. 2,3-alkyl sulfates, available from Shell Oil Company under the trade name DAN®, are also suitable anionic surfactants.

Sulfuric acid mono-esters derived from straight-chained or branched C₇₋₂₁ alcohols ethoxylated with 1 to 6 moles ethylene oxide are also suitable, such as 2-methyl-branched C₉₋₁₁ alcohols with an average of 3.5 mol ethylene oxide (EO), or C₁₂₋₁₈ fatty alcohols with 1 to 4 EO. It is even preferred that the inventive washing or cleaning agent comprises 0.01 to 5 wt. %, advantageously 0.5 to 3 wt. % and in particular 1.5 to 2.5 wt. % of an ethoxylated fatty alcohol sulfate, based on total weight of the agent.

Other suitable anionic surfactants include salts of alkylsulfosuccinic acid, also referred to as sulfosuccinates or esters of sulfosuccinic acid, and the monoesters and/or di-esters of sulfosuccinic acid with alcohols, preferably fatty alcohols and especially ethoxylated fatty alcohols. Preferred sulfosuccinates comprise C₈₋₁₈ fatty alcohol groups or mixtures of them. Especially preferred sulfosuccinates comprise a fatty alcohol group derived from ethoxylated fatty alcohols and may be considered as non-ionic surfactants (see description below). Again, especially preferred sulfosuccinates include those whose fatty alcohol groups are derived from ethoxylated fatty alcohols with narrow range distribution. It is also possible to use alk(en)ylsuccinic acids with preferably 8 to 18 carbon atoms in the alk(en)yl chain, or salts thereof.

The amount of anionic surfactants in a preferred washing or cleaning agent is preferably at least 3 wt. %, based on total weight of the washing or cleaning agent. However, the preferred amount of synthetic inorganic surfactants is at least 8 wt. %.

Surprisingly, it was found that fatty acid soaps have a detrimental influence on the stability of the inventive washing or cleaning agents. In contrast, synthetic anionic surfactants, even in large quantities, can be incorporated without problem and afford stable, clear products. For this reason, the liquid washing or cleaning agent preferably comprises no more than 2 wt. % and particularly preferably not more than 0.5 wt. % fatty acid soaps, based on total weight of the washing or cleaning agent. In a quite particularly preferred embodiment, the agent is essentially free of fatty acid soaps.

In the event that a fatty acid soap is incorporated into the washing or cleaning agent, then saturated and unsaturated fatty acid soaps are suitable, such as the salts of lauric acid, myristic acid, palmitic acid, stearic acid, (hydrogenated) erucic acid and behenic acid, and especially soap mixtures derived from natural fatty acids such as coconut oil fatty acid, palm kernel oil fatty acid, olive oil fatty acid or tallow fatty acid.

Anionic surfactants, including soaps when present, can be in the form of their sodium potassium or magnesium salts. Anionic surfactants are preferably present in the form of their sodium salts.

However, it may be preferred that the washing or cleaning agent has a washing or cleaning agent matrix that is based only on non-ionic surfactants. In particular, with respect to environmental friendliness of the washing or cleaning agent, it may be preferred that the washing or cleaning agent predominantly comprises surfactants from sustainable raw materials, and the fraction of synthetic surfactants is as low as possible or nearly zero.

In addition to the optical brightener, the color transfer inhibitor and the surfactant(s), the washing or cleaning agents can further comprise additional ingredients that improve the technological and/or esthetic properties of the washing or cleaning agent. In the context of the present invention, the washing or cleaning agent can additionally comprise one or more materials from the group of builders, bleaches, bleach catalysts, bleach activators, enzymes, electrolytes, non-aqueous solvents, pH adjustors, perfumes, perfume carriers, dyes, hydrotropes, foam inhibitors, silicone oils, anti-redeposition agents, optical brighteners, graying inhibitors, laddering retardants, anti-crease agents, antimicrobials, germicides, fungicides, antioxidants, preservatives, corrosion inhibitors, antistats, bittering agents, ironing aids, water-repellents and impregnation agents, swelling and non-skid agents, softening components and UV-absorbers.

Silicates, aluminum silicates (particularly zeolites), carbonates, salts of organic di- and polycarboxylic acids, as well as mixtures of these materials can be particularly used as builders in the washing or cleaning agent.

Suitable crystalline, layered sodium silicates correspond to the general formula NaMSiₓO₂ₓ₊₁H₂O, wherein M is sodium or hydrogen, x is a number from 1.9 to 4 and y is a number from 0 to 20, and preferred values for x are 2, 3 or 4. Preferred crystalline layered silicates of the given formula are those wherein M is sodium and x assumes the values 2 or 3. In particular, both β- and δ-sodium disilicates Na₂Si₂O₅yH₂O are preferred.

Other useful builders include amorphous sodium silicates with a modulus (Na₂O:SiO₂ ratio) of 1:2 to 1:3.3, preferably 1:2 to 1:2.8 and more preferably 1:2 to 1:2.6, which dissolve with a delay and exhibit multiple wash cycle properties. The delay in dissolution compared with conventional amorphous sodium silicates can be obtained in various ways, for example, by surface treatment, compounding, compressing/compacting or by over-drying. In the context of this invention, the term “amorphous” also means “X-ray amorphous”. In other words, the silicates do not produce any of the sharp X-ray reflections typical of crystalline substances, but, at best, one or more maxima of the scattered X-radiation, which have a width of several degrees of the diffraction angle. Still, particularly good builder properties may even be achieved where the silicate particles produce indistinct or even sharp diffraction maxima in electron diffraction experiments. This can be interpreted to mean that the products have microcrystalline regions from 10 up to a few hundred nm in size, with values of up to at most 50 nm, and especially up to at most 20 nm being preferred. Compacted/densified amorphous silicates, compounded amorphous silicates and over dried X-ray-amorphous silicates are particularly preferred.

Of the suitable fine crystalline, synthetic zeolites containing bound water, zeolite A and/or P are preferred. Zeolite MAP® (commercial product of the Crosfield company), is particularly preferred as the zeolite P. However, zeolite X and mixtures of A, X and/or P are also suitable. Commercially available and preferably used in the context of the present invention is, for example, also a co-crystallizate of zeolite X and zeolite A (ca. 80 wt. % zeolite X), which is marketed by the SASOL Company under the trade name VEGOBOND AX® and which can be described by the Formula

nNa₂O(1-n)K₂OAI₂O₃(2-2.5)SiO₂(3.5-5.5)H₂O

with n=0.90-1.0.

The zeolite can be employed as a spray-dried powder or also as a non-dried, stabilized suspension that is still moist from its manufacture. When the zeolite is added as a suspension, this can comprise small amounts of non-ionic surfactants as stabilizers, for example 1 to 3 wt. %, based on the zeolite, of ethoxylated C₁₂-C₁₈ fatty alcohols with 2 to 5 ethylene oxide groups, C₁₂-C₁₄ fatty alcohols with 4 to 5 ethylene oxide groups or ethoxylated isotridecanols. Suitable zeolites have a mean particle size of less than 10 μm (volume distribution, as measured by the Coulter Counter Method) and contain preferably 18 to 22% by weight, and more preferably 20 to 22% by weight of bound water.

Naturally, the generally known phosphates can also be added as builders, in so far that their use is not prevented on ecological grounds. Sodium salts of orthophosphates, pyrophosphates and especially tripolyphosphates are particularly suitable.

Organic builders that can be present in the washing or cleaning agent are, for example, polycarboxylic acids usable in the form of their sodium salts, polycarboxylic acids in this context being understood to be carboxylic acids that carry more than one acid function. These include, for example, citric acid, adipic acid, succinic acid, glutaric acid, malic acid, tartaric acid, maleic acid, fumaric acid, sugar acids, aminocarboxylic acids, nitrilotriacetic acid (NTA), methylglycine diacetic acid (MGDA) and their derivatives and mixtures thereof. Preferred salts include salts of polycarboxylic acids such as citric acid, adipic acid, succinic acid, glutaric acid, tartaric acid, sugar acids and mixtures thereof.

Acids per se can also be used. Besides their building effect, acids also typically have the property of an acidifying component and hence also serve to establish a relatively low and mild pH in washing or cleaning agents. Citric acid, succinic acid, glutaric acid, adipic acid, gluconic acid and any mixtures thereof are particularly mentioned in this regard. Additionally known pH adjustors such as sodium hydrogen carbonate and sodium hydrogen sulfate are also useful.

Polymeric polycarboxylates are also suitable as builders. They include alkali metal salts of polyacrylic or polymethacrylic acid, for example, those with a relative molecular weight of 500 to 70,000 g/mol.

Molecular weights mentioned in this specification for polymeric polycarboxylates are weight-average molecular weights M_{w} of the particular acid form which, fundamentally, were determined by gel permeation chromatography (GPC), equipped with a UV detector. The measurement was carried out against an external polyacrylic acid standard, which provides realistic molecular weight values by virtue of its structural similarity to the polymers investigated. These values differ significantly from molecular weights measured against polystyrene sulfonic acids as the standard. Molecular weights measured against polystyrene sulfonic acids are generally significantly higher than the molecular weights mentioned in this specification.

Particularly suitable polymers are polyacrylates, which preferably have a molecular weight of 2000 to 20,000 g/mol. By virtue of their superior solubility, preferred representatives of this group are again the short-chain polyacrylates, which have molecular weights of 2000 to 10,000 g/mol and, more particularly, 3000 to 5000 g/mol.

Suitable polymers can also include substances that consist partially or totally of vinyl alcohol units or its derivatives.

Further suitable copolymeric polycarboxylates include those of acrylic acid with methacrylic acid and of acrylic acid or methacrylic acid with maleic acid. Copolymers of acrylic acid with maleic acid, which comprise 50 to 90 wt. % acrylic acid and 50 to 10 wt. % maleic acid, have proven to be particularly suitable. Their relative molecular weight, based on free acids, generally ranges from 2000 to 70,000 g/mol, preferably 20,000 to 50,000 g/mol and especially 30,000 to 40,000 g/mol. The (co)polymeric polycarboxylates can be added either as an aqueous solution or preferably as powder.

In order to improve water solubility, the polymers can also comprise allyl sulfonic acids such as allyloxybenzene sulfonic acid and methallyl sulfonic acid as the monomer.

Particular preference is also given to biodegradable polymers comprising two or more different monomer units, for example, those comprising, as monomers, salts of acrylic acid and of maleic acid, and also vinyl alcohol or vinyl alcohol derivatives, or those comprising, as monomers, salts of acrylic acid and of 2-alkylallyl sulfonic acid, and also sugar derivatives.

Other preferred copolymers include those which preferably contain acrolein and acrylic acid/acrylic acid salts or acrolein and vinyl acetate as monomers.

Similarly, other preferred builders include polymeric amino dicarboxylic acids, salts or precursors thereof. Particularly preferred are those polyaspartic acids or their salts and derivatives that have, to some extent, a bleach-stabilizing action in addition to builder properties.

Further preferred builders include polyacetals obtainable by treating dialdehydes with polyol carboxylic acids possessing 5 to 7 carbon atoms and at least 3 hydroxyl groups. Preferred polyacetals are obtained from dialdehydes like glyoxal, glutaraldehyde, terephthalaldehyde, as well as their mixtures and from polycarboxylic acids like gluconic acid and/or glucoheptonic acid.

Further suitable organic builders include dextrins, for example oligomers or polymers of carbohydrates obtained from the partial hydrolysis of starches. The hydrolysis can be carried out using typical processes, for example, acid or enzyme catalyzed processes. Hydrolysis products preferably have average molecular weights in the range of from 400 to 500,000 g/mol. A polysaccharide with a dextrose equivalent (DE) of 0.5 to 40 and, more particularly, 2 to 30 is preferred, DE being an accepted measure of the reducing effect of a polysaccharide compared to dextrose, which has a DE of 100. Maltodextrins, with a DE from 3 to 20, dry glucose syrups with a DE from 20 to 37, and yellow and white dextrins with relatively high molecular weights of 2000 to 30,000 g/mol may be used.

Oxidized derivatives of such dextrins refer to their reaction products with oxidizing agents capable of oxidizing at least one alcohol function of the saccharide ring to the carboxylic acid function. An oxidized oligosaccharide is also suitable. A product oxidized at C₆ of the saccharide ring can be particularly advantageous.

Oxydisuccinates and other derivatives of disuccinates, preferably ethylenediamine disuccinates, are also additional suitable cobuilders. Ethylenediamine-N,N′-disuccinate (EDDS) is preferably used here in the form of its sodium or magnesium salts. In this context, glycerine disuccinates and glycerine trisuccinates are also preferred.

Other useful organic co-builders include acetylated hydroxycarboxylic acids and salts thereof which optionally may also be present in lactone form and which comprise at least 4 carbon atoms, at least one hydroxyl group and at most two acid groups.

For esthetic reasons however, soluble, organic builders such as citric acid are preferably added to the aqueous washing and cleaning agents.

Sodium perborate tetrahydrate and sodium perborate monohydrate are of particular importance among compounds that serve as bleaching agents that liberate H₂O₂ in water. Examples of further bleaching agents that may be employed include sodium percarbonate, peroxypyrophosphates, citrate perhydrates and H₂O₂-liberating peracidic salts or peracids, such as perbenzoates, peroxyphthalates, diperoxyazelaic acid, diperoxydodecanedioic acid, 4-phthalimidoperoxybutanoic acid, 5-phthalimidoperoxypentanoic acid, 6-phthalimidoperoxyhexanoic acid, 7-phthalimidoperoxyheptanoic acid, N,N′-terephthaloyl-di-6-amino peroxyhexanoic acid. The most preferred peracids include phthalimide peroxyalkanoic acids, in particular 6-phthalimido peroxyhexanoic acid (PAP). The bleaching agent—when present—can be manufactured in a known manner by adding inert particulate carrier materials; it is preferably added in encapsulated form. The encapsulated material should release the encapsulated bleaching agent under the conditions of use of the washing or cleaning agent (at increased temperature, changing pH due to dilution with water, or similar). A preferred encapsulating material is one that consists, at least partially, of saturated fatty acid.

The amount of bleaching agent is preferably from 0.5 to 25 wt. %, based on total weight of the washing or cleaning agent.

The washing or cleaning agents can comprise bleach activators in order to achieve an improved bleaching action for washing temperatures of 60° C. and below. Compounds that yield aliphatic peroxycarboxylic acids under perhydrolysis conditions can be added as bleach activators. Preference is given to polyacylated alkylenediamines, in particular tetraacetyl ethylenediamine (TAED), acylated triazine derivatives, in particular 1,5-diacetyl-2,4-dioxohexahydro-1,3,5-triazine (DADHT), acylated glycolurils, in particular tetraacetyl glycoluril (TAGU), N-acylimides, in particular N-nonanoyl succinimide (NOSI), acylated phenol sulfonates, in particular n-nonanoyl- or isononanoyloxybenzene sulfonate (n- or iso-NOBS), carboxylic acid anhydrides, in particular phthalic anhydride, acylated polyhydric alcohols, in particular triacetin, ethylene glycol diacetate and 2,5-diacetoxy-2,5-dihydrofuran.

In addition to, or instead of conventional bleach activators, bleach catalysts may also be incorporated into the liquid detergents and cleaning compositions. These are bleach-boosting transition metal salts or transition metal complexes such as manganese-, iron-, cobalt-, ruthenium- or molybdenum-salen or -carbonyl complexes. Manganese, iron, cobalt, ruthenium, molybdenum, titanium, vanadium and copper complexes with nitrogen-containing tripod ligands and cobalt-, iron-, copper- and ruthenium-amine complexes may also be used as bleach catalysts.

If the liquid washing or cleaning agent includes a bleaching agent, bleach activator and/or bleach catalyst, then it is particularly advantageous if they are present in encapsulated form in the washing or cleaning agent. However, it is preferred that the washing or cleaning agent does not comprise any of these ingredients.

The liquid washing or cleaning agent can also include an enzyme or mixture of enzymes. Suitable enzymes include, in particular, hydrolases such as proteases, (poly) esterases, lipases or lipolytic enzymes, amylases, cellulases or other glycosyl hydrolases, hemicellulases, cutinases, β-glucanases, oxidases, peroxidases, mannanases, perhydrolases, oxidoreductases and/or laccases. In the context of the present invention, proteases, amylases, lipases, cellulases, mannanases, laccases, tannanases and esterases/polyesterases or mixtures of two or more of these enzymes are preferably added.

In the wash, hydrolases contribute to the removal of stains such as protein, fat or starch-containing stains and against graying. Cellulases and other glycosyl hydrolases can contribute to increased softness of the textile and to color retention by removing pilling and micro fibrils. Cellobiohydrolases, endoglucanases and β-glucosidases or mixtures thereof, which are also known as cellobiases, are preferred cellulases. As cellulases differ in their CMCase- and avicelase activities, the required activities can be adjusted by controlled mixtures of the cellulases.

Subtilisin proteases, particularly proteases that are obtained from Bacillus lentus, are preferably used. Here, mixtures of enzymes are of particular interest (e.g., proteases and amylases, or proteases and lipases, or lipolytic enzymes or proteases and cellulases, or cellulases and lipases, or lipolytic enzymes or proteases, amylases and lipases or lipolytic enzymes or proteases, lipases or lipolytic enzymes and cellulases, in particular, proteases and/or lipase-containing mixtures or mixtures with lipolytic enzymes). Examples of such lipolytic enzymes include cutinases. Suitable amylases particularly include α-amylases, iso-amylases, pullulanases and pectinases.

The amount of enzyme(s) is from 0.01 to 10 wt. %, preferably from 0.12 to about 3 wt. %, based on total weight of the composition. The enzymes are preferably added as a liquid enzyme formulation(s). If the washing or cleaning agent comprises a mixture of enzymes, then at least one enzyme can be in the form of a granulate, be encapsulated or be adsorbed on carrier materials. Quite preferred washing or cleaning agents comprise cellulase; cellulase and protease; cellulase, protease and amylase; cellulase, protease, amylase and lipase or cellulase, protease, amylase, lipase and (poly)esterase.

The inventive washing or cleaning agents can also include stabilizers for stabilizing the enzymes, such as boric acid or borates, boric acid derivatives or amino alcohols.

A large number of the various salts from the group of inorganic salts can be employed as electrolytes. Preferred cations include alkali metal and alkaline earth metals; preferred anions include halides and sulfates. The fraction of electrolytes in the washing or cleaning agents normally ranges from 0.1 to 5 wt. %.

The liquid washing or cleaning agent can also comprise one or more non-aqueous solvents in addition to the main solvent water. Non-aqueous solvents that can be added to the washing or cleaning agent originate, for example, from the group of mono- or polyhydric alcohols, alkanolamines or glycol ethers, to the extent that they are miscible with water in the defined concentration range. Solvents which can be employed include ethanol, n- or i-propanol, butanols, glycol, propane diol or butane diol, glycerin, diglycol, propyl diglycol or butyl diglycol, hexylene glycol, ethylene glycol methyl ether, ethylene glycol ethyl ether, ethylene glycol propyl ether, ethylene glycol mono-n-butyl ether, diethylene glycol methyl ether, diethylene glycol ethyl ether, propylene glycol methyl-, -ethyl- or -propyl ether, dipropylene glycol monomethyl-, or -ethyl ether, di-isopropylene glycol monomethyl- or -ethyl ether, methoxy-, ethoxy- or butoxy triglycol, 1-butoxyethoxy-2-propanol, 3-methyl-3-methoxybutanol, propylene glycol t-butyl ether as well as mixtures of these solvents. Non-aqueous solvents can be added to the washing or cleaning agent in amounts of from 0.5 to 25 wt. %, preferably, however 20 wt. % or less, and particularly 15 wt. % or less.

It is preferred that the washing or cleaning agent includes a polyol as the non-aqueous solvent. In particular, the polyol can include glycerin, 1,2-propane diol, 1,3-propane diol, ethylene glycol, diethylene glycol and/or dipropylene glycol. The washing or cleaning agent particularly preferably comprises a mixture of at least two polyols. In this respect, mixtures of 1,2-propane diol and dipropylene glycol, 1,2-propane diol and diethylene glycol or glycerin and diethylene glycol are preferred.

pH adjustors can be added to bring the pH of the washing or cleaning agent into the neutral range. Any known acid or alkali can be added to the extent their use is not prohibited on technological or ecological grounds or consumer protection grounds. The amount of these adjustors does not normally exceed 10 wt. % of the total formulation.

The liquid washing or cleaning agent can include a thickener. Examples of thickeners include a polyacrylate thickener, xanthan gum, gellan gum, guar nut flour, alginate, carragheenan, carboxymethylcellulose, bentonite, wellan gum, locust bean flour, agar-agar, traganth, gummi arabicum, pectins, polyoses, starches, dextrins, gelatines and casein. However, modified natural products such as modified starches and celluloses (examples being carboxymethyl cellulose and other cellulose ethers, hydroxyethyl and hydroxypropyl cellulose as well as bean flour ether) can also be employed as the thickener.

Polyacrylic and polymethacrylic thickeners include, for example, high molecular weight homopolymers of acrylic acid crosslinked with a polyalkenyl polyether, in particular, an allyl ether of saccharose, pentaerythritol or propylene (INCI name according to the “International Dictionary of Cosmetic Ingredients” of “The Cosmetic, Toiletry and Fragrance Association (CTFA)”: Carbomer), which are also called carboxyvinyl polymers. Such polyacrylic acids are available inter alia from 3V Sigma Company under the trade name Polygel® (e.g., Polygel DA), and from the Noveon Company under the trade name Carbopol® (e.g., Carbopol® 940 having a molecular weight ca. 4,000,000, Carbopol® 941 having a molecular weight ca. 1,250,000, or Carbopol® 934 having a molecular weight ca. 3,000,000). In addition, the following acrylic acid copolymers are included: (i) copolymers of two or more monomers from the group of acrylic acid, methacrylic acid and their simple esters, preferably formed with C₁₋₄ alcohols, (INCI acrylate copolymer), to which belong, for example, copolymers of methacrylic acid, butyl acrylate and methyl methacrylate (CAS number according to Chemical Abstracts Service: 25035-69-2) or of butyl acrylate and methyl methacrylate (CAS 25852-37-3) and which are available, for example, from Rohm & Haas under the trade names Aculyn® and Acusol® (e.g., the anionic non-associative polymers Aculyn 22, Aculyn 28, Aculyn 33 (crosslinked), Acusol 810, Acusol 820, Acusol 823 and Acusol 830 (CAS 25852-37-3)), and from Degussa (Goldschmidt) under the trade names Tego® Polymer; (ii) crosslinked high molecular weight acrylic acid copolymers that include, for example, copolymers of C₁₀₋₃₀ alkyl acrylates and one or more monomers from the group of acrylic acid, methacrylic acid and their simple esters, preferably formed with C₁₋₄ alcohols, which are crosslinked with an allyl ether of saccharose or of pentaerythritol (INCI Acrylates/C10-30 alkyl acrylate crosspolymer), and which are available from the B.F. Goodrich Company under the trade name Carbopol® (e.g., the hydrophobized Carbopol ETD 2623 and Carbopol 1382 (INCI Acrylates/C10-30 Alkyl Acrylate Crosspolymer) as well as Carbopol Aqua 30 (previously Carbopol EX 473)). Further suitable thickeners based on (meth)acrylic acid (co)polymers include Carbopol® Aqua 30 (ex Noveon) or polyacrylate thickeners that are commercialized by BASF under the trade name Sokalan®.

Preferred liquid washing or cleaning agents can have viscosities from 200 to 5000 mPas, wherein values from 300 to 2000 mPas and particularly 400 to 1000 mPas are preferred. Viscosity is measured with a Brookfield-Viscosimeter LVT-II at 20 rpm and 20° C., spindel 3.

In a preferred embodiment, the washing or cleaning agent comprises one or more perfumes, normally in an amount of up to 15 wt. %, preferably 0.01 to 5 wt. %, particularly 0.3 to 3 wt. %, based on total weight of the agent. Suitable perfume oils or fragrances that can be used include individual perfume compounds such as synthetic products of the ester, ether, aldehyde, ketone, alcohol and hydrocarbon type. However, mixtures of various odoriferous substances that together produce an attractive fragrant note are preferably used. Such perfume oils can also comprise natural mixtures of odoriferous compounds, available from vegetal sources.

In order to esthetically enhance the washing or cleaning agent, they may be colored with appropriate colorants. Preferred colorants, which are not difficult for the person skilled in the art to choose, have high storage stability, are not affected by the other ingredients of the washing or cleaning agent or by light and do not have any pronounced substantivity for textile fibers, so as not to color them.

Soaps, paraffins or silicone oils, especially silicone oils, optionally in the form of emulsions, are examples of foam inhibitors that can be incorporated into the washing or cleaning agents.

Suitable anti-redeposition agents, also referred to as soil repellents, include non-ionic cellulose ethers such as methyl cellulose and methyl hydroxypropyl cellulose with a content of methoxy groups of 15 to 30 wt. % and hydroxypropyl groups of 1 to 15 wt. %, each based on the non-ionic cellulose ether, as well as polymers of phthalic acid and/or terephthalic acid or their derivatives known from the prior art, particularly polymers of ethylene terephthalates and/or polyethylene- and/or polypropylene glycol terephthalates or anionically and/or non-ionically modified derivatives thereof. Suitable derivatives include sulfonated derivatives of phthalic acid polymers and terephthalic acid polymers.

Graying inhibitors suspend dirt removed from the fibers in the washing liquor, thereby preventing the dirt from resettling. Water-soluble colloids of mostly organic nature are suitable for this (e.g., glue, gelatines, salts of ether sulfonic acids of starches or celluloses, or salts of acidic sulfuric acid esters of celluloses or starches). Water-soluble, acid group-containing polyamides are also suitable for this purpose. In addition, soluble starch preparations and others can be used as the abovementioned starch products (e.g., degraded starches, aldehyde starches etc.). Polyvinyl pyrrolidone can also be used. Preferably, cellulose ethers such as carboxymethyl cellulose (Na salt), methyl cellulose, hydroxyalkyl cellulose and mixed ethers such as methyl hydroxyethyl cellulose, methyl hydroxypropyl cellulose, methyl carboxymethyl cellulose and mixtures thereof are used, which can be added, for example, in amounts of 0.1 to 5 wt. %, based on total weight of the washing or cleaning agent.

As textile fabrics, particularly of rayon, spun rayon, cotton and their mixtures tend to crease because the individual fibers are sensitive to flection, bending, pressing and squeezing at right angles to the fiber direction, the laundry detergents or cleaning agents can comprise synthetic anti-crease agents. These include synthetic products based on fatty acids, fatty acid esters, fatty acid amides, fatty acid alkylol esters, fatty acid alkylol amides or fatty alcohols that have been mainly treated with ethylene oxide, or products based on lecithin or modified phosphoric acid esters.

The washing or cleaning agents can have antimicrobial agents for controlling microorganisms. Depending on the antimicrobial spectrum and the action mechanism, antimicrobial agents are classified as bacteriostatic agents and bactericides, fungistatic agents and fungicides, etc. Important representatives of these groups include benzalkonium chlorides, alkylaryl sulfonates, halophenols and phenol mercuric acetate, which can also be dispensed within the inventive washing or cleaning agents.

The inventive washing or cleaning agents can have preservatives. Preferably only those are used which have no or only a slight skin sensitizing potential. Examples include sorbic acid and its salts, benzoic acid and its salts, salicylic acid and its salts, phenoxyethanol, formic acid and its salts, 3-iodo-2-propynylbutyl carbamate, sodium N-(hydroxymethyl)glycinate, biphenyl-2-ol as well as mixtures thereof. Isothiazolones, mixtures of isothiazolones and mixtures of isothiazolones with other compounds, for example, tetramethylol glycoluril, illustrate further suitable preservatives.

The washing or cleaning agents can include antioxidants for preventing undesirable changes caused by oxygen and other oxidative processes to the washing or cleaning agents and/or the treated textile fabrics. This class of compounds includes, for example, substituted phenols, hydroquinones, pyrocatechols and aromatic amines, as well as organic sulfides, polysulfides, dithiocarbamates, phosphites, phosphonates and vitamin E.

Increased wear comfort can result from the additional use of antistats additionally included in the washing or cleaning agents. Antistats increase surface conductivity, thereby allowing an improved discharge of built-up charges. Generally, external antistats are substances with at least one hydrophilic molecule ligand and provide a more or less hygroscopic film on surfaces. These mainly interfacially active antistats can be subdivided into nitrogen-containing (amines, amides, quaternary ammonium compounds), phosphorus-containing (phosphoric acid esters) and sulfur-containing (alkyl sulfonates, alkyl sulfates) antistats. Lauryl (or stearyl) dimethyl benzyl ammonium chlorides are suitable antistats for textile fabrics or as additives to laundry detergents or cleaning agents, resulting in an additional finishing effect.

Silicone derivatives, for example, can be incorporated in the washing or cleaning agent to improve re-wettability of treated textile fabrics, as well as facilitate ironing of the treated textile fabrics. Because of their foam-inhibiting properties, they additionally improve the final rinse behavior of the washing or cleaning agent. Exemplary preferred silicone derivatives include polydialkylsiloxanes or alkylarylsiloxanes, wherein the alkyl groups possess one to five carbon atoms and are totally or partially fluorinated. Preferred silicones include polydimethylsiloxanes that can be optionally derivatized and then are aminofunctionally or quaternized or possess Si—OH, Si—H and/or Si—Cl bonds. Viscosities of the preferred silicones at 25° C. are in the range of from 100 to 100,000 mPas, wherein the silicones can be added in amounts of from 0.2 to 5 wt. %, based on total weight of the washing or cleaning agent.

Finally, the washing or cleaning agent can also include UV absorbers that are absorbed on the treated textile fabrics and improve the light stability of the fibers. Compounds, which possess these desired properties include, for example, efficient radiationless deactivating compounds and derivatives of benzophenone having substituents in position(s) 2 and/or 4. Also suitable are substituted benzotriazoles, acrylates, which are phenyl-substituted in position 3 (cinnamic acid derivatives), optionally with cyano groups in position 2, salicylates, organic Ni complexes, as well as natural substances such as umbelliferone and the endogenous urocanic acid.

Substances can be added to complex heavy metals in order to prevent heavy metal catalyzed decomposition of certain washing agent ingredients. Suitable heavy metal sequestrants include, for example, the alkali salts of ethylenediamine tetra acetic acid (EDTA) or of nitrilotriacetic acid (NTA), methylglycine diacetic acid (MGDA) as well as alkali metal salts of anionic polyelectrolytes such as polymaleates and polysulfonates.

A preferred class of sequestrants are the phosphonates that are present in a preferred washing or cleaning agent in amounts of 0.01 to 2.5 wt. %, preferably 0.02 to 2 wt. % and particularly 0.03 to 1.5 wt. %, based on total weight of the agent. These preferred compounds particularly include organo phosphonates such as 1-hydroxyethane-1,1-diphosphonic acid (HEDP), amino tri(methylene phosphonic acid) (ATMP), diethylenetriamine penta(methylene phosphonic acid) (DTPMP or DETPMP), as well as 2-phosphono butane-1,2,4-tricarboxylic acid (PBS-AM), which are mainly added in the form of their ammonium or alkali metal salts. Alternative sequestrants that can be added to the washing or cleaning agent are imino disuccinates (IDS) or ethylenediamine-N,N-disuccinate (EDDS).

The washing or cleaning agents according to the invention can be used for cleaning textile fabrics.

The washing or cleaning agent is prepared by usual and known methods and processes, for example, by simply blending the ingredients of the washing or cleaning agent in stirred tanks, wherein water, non-aqueous solvents and surfactants are advantageously present. The fatty acid is then added and saponification is carried out at 50 to 60° C. Additional ingredients are then added, preferably in portions. Should the washing or cleaning agent comprise ingredients that still have to be neutralized (e.g., anionic surfactants, acids etc.), then these are then neutralized and the water, the non-aqueous solvent and the additional, especially non-ionic surfactants, are then added. The color transfer inhibitor and the optical brightener can be stirred into the washing or cleaning agent in a “post-addition” step. However, it is preferred if the addition of the optical brightener is made at a different time from the addition of the color transfer inhibitor, and that at least two additional ingredients are added between the addition of the optical brightener and the color transfer inhibitor.

Particularly stable washing or cleaning agents comprising an optical brightener and a color transfer inhibitor are obtained if one component (optical brightener or color transfer inhibitor) is added in a very early stage of the manufacturing process and the other is added in a later stage, in particular, as a post addition. It is particularly advantageous if the optical brightener is added together with water, the non-aqueous solvents and the (non-ionic) surfactants, and the color transfer inhibitor is added in a “post”-addition step.

In the following Table 1 are shown compositions of two inventive washing or cleaning agents E1 and E2 as well as the composition of a comparative formulation V1 (all amounts are given in wt. % active substance, based on total composition).

TABLE 1
Composition of Washing or Cleaning
Agents E1, E2 and V1 (in wt. %)

| | E1 | E2 | V1 |
|---|---|---|---|
| C₁₂₋₁₈ fatty alcohol | 10 | 10 | 10 |
| with 7 EO | | | |
| sodium lauryl ether | 2 | 2 | 2 |
| sulfate with 2 EO | | | |
| linear C₁₀-C₁₃ alkylbenzene | 16 | 16 | 16 |
| sulfonic acid | | | |
| citric acid | 3 | 3 | 3 |
| phosphonic acid | 0.7 | 0.7 | 0.7 |
| boric acid | 1 | 1 | 1 |
| polyacrylate thickener | 1 | 1 | 1 |
| NaOH (50% conc.) | 4.00 | 3.92 | 4.15 |
| optical brightener* | 0.045 | 0.06 | 0.06 |
| color transfer inhibitor** | 0.4 | 0.4 | 0.4 |
| soil-release polymer*** | 0.8 | 0.8 | 0.8 |
| 1,2-propane diol | 6.5 | 6.5 | 6.5 |
| diethylene glycol | 2 | 2 | 2 |
| ethanol | 3 | 3 | 3 |
| silicone defoamer | 0.01 | 0.01 | 0.01 |
| enzymes (amylase, | 1.4 | 1.4 | 1.4 |
| protease & cellulase) | | | |
| perfume | 0.9 | 0.9 | 0.9 |
| colorant | + | + | + |
| water | ad 100 | ad 100 | ad 100 |
| pH | 7 | 7 | 7.6 |
| appearance | clear, | clear, | turbid, phase- |
| | phase stable | phase stable | separation |

*Disodium-2,2′-bis-(phenyl-styryl)disulfonate (Tinopal ® CBS from Ciba Speciality Chemicals AG)
**Copolymers of vinyl pyrrolidone and vinylimidazole (PVP/PVI) (Sokalan ® HP 56 from BASF)
***Polyethylene glycol polyester (Repel-O-Tex ® SRP-6 from Rhodia)

Viscosity of the three compositions was between 500 mPas and 600 mPas (Brookfield-Viscosimeter LVT-II at 20 rpm and 20° C., spindel 3). The washing or cleaning agents compositions E1 and E2 were clear and storage stable for more than 12 weeks, whereas the comparative composition V1 became very turbid shortly after manufacture and finally separated into two phases.

Washing or cleaning agents E1 and E2 each demonstrated very good cleaning power. In addition, when multi-colored textiles were treated with the inventive washing or cleaning agents, no discoloration appeared on the lighter areas of the textiles. The white areas of the textiles did not show any graying and/or yellowing phenomena.

The washing or cleaning agents E1 and E2 were manufactured by firstly providing about 80% of the added water, the non-aqueous solvent, the surfactants (except for the linear C₁₀-C₁₃ alkylbenzene sulfonic acid). To this mixture were added the acids (citric acid, boric acid and phosphonic acid) followed by neutralization with an excess of NaOH. The optical brightener was then added. After having added the linear C₁₀-C₁₃ alkylbenzene sulfonic acid and after cooling, the acrylate thickener was added with the remaining water. The ethanol, the defoamer, the soil-release polymer and the colorant were then added in any order with stirring. Finally, the color transfer inhibitor, the perfume and the enzymes were added.

We claim:

1. Aqueous washing or cleaning agent comprising:
an optical brightener,
a color transfer inhibitor, and
one or more surfactant(s),
wherein the pH of the agent is in a neutral range of 6.5 to 7.5.

2. Washing or cleaning agent according to claim 1 wherein the pH of the agent is in the range 6.8 to 7.2.

3. Washing or cleaning agent according to claim 1 wherein the agent contains more than 3 wt. % synthetic anionic surfactant.

4. Washing or cleaning agent according to claim 3 wherein the synthetic anionic surfactant is chosen from alkylbenzene sulfonates, alkane sulfonates, olefin sulfonates, methyl ester sulfonates, alkyl sulfates, alkenyl sulfates, alkyl ether sulfates, alkenyl ether sulfates and mixtures thereof.

5. Washing or cleaning agent according to claim 1 further comprising no more than 2 wt. % fatty acid soap.

6. Washing or cleaning agent according to claim 5 wherein the agent is substantially free of fatty acid soap.

7. Washing or cleaning agent according to claim 1, wherein the optical brightener is chosen from distyrylbiphenyls, stilbenes, 4,4-diamino-2,2′-stilbene disulfonic acids, coumarins, dihydroquinolinones, 1,3-diarylpyrazolines, naphthalic acid imides, benzoxazole systems, benzisoxazole systems, benzimidazole systems, heterocycle-substituted pyrene derivatives and mixtures thereof.

8. Washing or cleaning agent according to claim 7 wherein the optical brightener is chosen from disodium-4,4′-bis-(2-morpholino-4-anilino-s-triazin-6-ylamino)stilbene disulfonate, disodium-2,2′-bis-(phenyl-styryl)disulfonate, 4,4′-bis[(4-anilino-6-[bis(2-hydroxyethyl)amino]-1,3,5-triazin-2-yl)amino]stilbene-2,2′-disulfonic acid, hexasodium-2,2′-[vinylene bis[(3-sulfonato-4,1-phenylene)imino[6-(diethylamino)-1,3,5-triazin-4,2-diyl]imino]]bis-(benzene-1,4-disulfonate), 2,2′-(2,5-thiophenediyl)bis[5-1,1-dimethylethyl)benzoxazole, 2,5-bis(benzoxazole-2-yl)thiophene and mixtures thereof.

9. Washing or cleaning agent according to claim 1, wherein the color transfer inhibitor is chosen from polyvinyl pyrrolidone (PVP), polyvinylimidazole (PVI), copolymers of vinyl pyrrolidone and vinylimidazole (PVP/PVI), polyvinylpyridine-N oxide, poly-N-carboxymethyl-4-vinylpyridium chloride and mixtures thereof.

10. Washing or cleaning agent according to claim 1, wherein the optical brightener is present in an amount of 0.001 to 0.25 wt. %, based on total weight of the washing and cleaning agent.

11. Washing or cleaning agent according to claim 1, wherein the color transfer inhibitor is present in an amount of 0.02 to 0.6 wt. %, based on total weight of the washing and cleaning agent.

12. Process for manufacturing an aqueous washing or cleaning agent comprises:
preparing a solution of water and one or more surfactants,
adding an optical brightener to the solution,
adding a color transfer inhibitor to the solution at a different time from the addition of the optical brightener,
adding one or more additional washing or cleaning agents ingredients to the solution, and
adjusting the pH of the agent to a neutral value of 6.5 to 7.5.

13. Process according to claim 12, wherein at least two additional ingredients of the washing or cleaning agent are added between the addition of the optical brightener and the color transfer inhibitor.
